(19) United States
(12) Patent Application Publication
(10) Pub. No.: US 2010/0138494 A1
(43) Pub. Date: Jun. 3, 2010

(54) CONTENT REDISTRIBUTION SYSTEM BASED ON PEER-TO-PEER NETWORK AS WELL AS CONTENT MANAGEMENT TERMINAL AND ITS CONTENT DISTRIBUTION METHOD

(76) Inventors: Il Woo LEE, Daejeon (KR); Moonok CHOI, Daejeon (KR); Shin Yuk KANG, Daejeon (KR); Hae Ryong LEE, Daejeon (KR); Ho Jin PARK, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/485,111

(22) Filed: Jun. 16, 2009

(30) Foreign Application Priority Data
Dec. 1, 2008 (KR) 10-2008-0120799
Apr. 21, 2009 (KR) 10-2009-0034779

(51) Int. Cl. G06F 15/16; G06Q 30/00

(52) U.S. Cl. 709/204; 705/14.4; 705/14.52; 709/231

(57) ABSTRACT

A content redistribution system based on a peer-to-peer (P2P) network includes: a content management terminal that, being a peer of the P2P network, decides for redistribution of contents based on characteristic information included in the contents received via a heterogeneous network; and peer terminals to which are distributed the contents decided for redistribution according to data transmission regulations in a community group on the P2P network.

### CROSS-REFERENCE(S) TO RELATED APPLICATION(S)

The present invention claims priority of Korean Patent Application No. 10-2008-0120799, filed on Dec. 1, 2008, and No. 10-2009-0034779, filed on Apr. 21, 2009, which is incorporated herein by reference.

### FIELD OF THE INVENTION

The present invention relates to redistribution of contents based on a peer-to-peer network, and, in particular, to a content redistribution system based on a peer-to-peer network that can redistribute contents on a heterogeneous network via a peer-to-peer network as well as a content management terminal and its content distribution method.

### BACKGROUND OF THE INVENTION

It is well known that expandability, security, reliability, flexibility to new services and quality of services, among other things, are prime features required in internet-based applications of the future. While a server-client system may be regarded as an amenable means to realize these features, it is often greatly hampered by the problems of complexity and high cost. On the other hand, a simpler solution has been suggested by a telecommunication method based on a peer-to-peer (hereinafter, referred to as P2P) network thanks to its accessibility to distributive resources of all forms.

In general, P2P technology provides users on various wired and wireless networks with services to share mutual resources by using user terminals under ubiquitous circumstances. With the rapid progress of telecommunication environment and recent advent of high-performance personal terminals, there arises a constantly increasing demand for a means to be capable of sharing contents among devices and of coupling of services free of time or place. To cope with the demand, P2P technology forms a virtual space and provides with seamless connections among personal terminals in order for the individual users to be able to search for and share the contents and services among the terminals on the network.

As an emerging technology of great importance, Internet Protocol Television (hereinafter, referred to as IPTV) has been widely regarded as a next-generation telecommunication-broadcasting service. IPTV includes a headend, a relay network, a subscriber network and subscribers' homes. Being a server-client model, it provides a multitude of subscribers with services in multicast from the content server. The headend is composed of various servers including an authentication server and an accounting server, encoders and video-on-demand servers. The traffic passes through the relay network and subscriber network en route and is transmitted finally to subscribers' homes. Contents entered into a subscriber's home via a router and modem are passed onto an IPTV set-top box en route and output finally on a subscriber's display device like a television.

It is anticipated in general that IPTV would extend the simple video distribution service in its initial phase not only to bidirectional services communicating with the subscribers but ultimately to one that combines off-line services following the stream of the industry. Despite IPTV is regarded at present as a bidirectional television or an adaptive television evolved from the conventional unidirectional television, it is expected that, through evolutions via communication, home network and community, IPTV would play an important role in the domain of future internet services.

In view of the present status of IPTV technology, however, it is difficult to satisfy with the present-day IPTV technology the ever-increasing demands in areas such as home network coupling and community services. Since there has been a rapid increase in consumer contents of prosumer type that the users themselves produce, a viable environment is needed for these various multimedia contents to be efficiently distributed among the users at subscribers' homes. In order to be able to allow all the users to access the network as IPTV subscribers and provide them with the contents without suffering from the ever-increasing load on the video-on-demand server, it is imperative to come up with a load-sharing plan such as clustering of central servers and installation of regional servers.

### SUMMARY OF THE INVENTION

As addressed in the above, IPTV is a service model that is aptly suited to provide a multicast broadcasting service among a content provider and its users. However, it requires additional technologies and skills in order to be able to circulate among the users multimedia contents including IPTV contents and provide with community services.

It is, therefore, an object of the present invention to provide a content redistribution system based on a peer-to-peer network that can redistribute IPTV contents on a heterogeneous network via a peer-to-peer network as well as a content management terminal and its content distribution method.

In accordance with a first aspect of the present invention, there is provided a content redistribution system based on a peer-to-peer (P2P) network, including: a content management terminal that, being a peer of the P2P network, decides for redistribution of contents based on characteristic information included in the contents received via a heterogeneous network; and peer terminals to which are distributed the contents decided for redistribution according to data transmission regulations in a community group on the P2P network.

It is preferred that the content management terminal receives the contents from a streaming server on an internet protocol television network as the heterogeneous network. It is also preferred that the content management terminal stores and transmits the contents in chunks based on chunk information included in the characteristic information. It is desired that the content management terminal stores and transmits the contents in chunks of a prescribed size if chunk information is not present in the characteristic information. It is preferable that the content management terminal streams the contents in the chunks. Further, the content management terminal may transmit sequentially the contents in the chunks. It is also preferable that the content management terminal transmits buffer map information to the peer terminals and transmits the contents in the chunks at random based on the buffer map information.

In accordance with a second aspect of the present invention, there is provided a content management terminal that is a member of a peer-to-peer network and manages contents, including: a content receiver that receives contents via a heterogeneous network; a redistribution decision unit that decides for redistribution based on characteristic information included in the contents; a content storage that stores in chunks contents received by the content receiver; a group manager that stores and manages information about a community group; an advertisement processor that transmits messages advertising the contents based on information about the community group to peer terminals affiliated with the community group; and a content transmitter that redistributes in the chunks the contents decided for redistribution to the peer terminals which request the contents based on the advertising messages.

It is desired that the content management terminal receives the contents from the heterogeneous network as a streaming server on an internet protocol television network. Further, the content receiver and the content transmitter may store and transmit the contents in the chunks based on chunk information included in the characteristic information. It is also preferable that the content storage stores and transmits the contents in chunks of a prescribed size if chunk information is not present in the characteristic information. It is preferred that the content transmitter streams the contents in the chunks. It is also desired that the content transmitter transmits sequentially the contents in the chunks. It is also preferred that the content transmitter transmits buffer map information to the peer terminals and transmits the contents in the chunks at random based on the buffer map information.

In accordance with a third aspect of the present invention, there is provided a content distribution method for a content management terminal that is a member of a peer-to-peer network and manages contents, including: receiving the contents via a heterogeneous network; deciding for redistribution based on characteristic information included in the contents; and distributing the contents decided for redistribution to the peer terminals on the P2P network according to data transmission regulations in a community group on the P2P network.

It is preferred that the receiving receives the contents from a streaming server on an internet protocol television network as the heterogeneous network. Further, the distributing may transmit the contents in chunks based on chunk information included in the characteristic information. It is desired that the distributing transmits the contents in chunks of a prescribed size if chunk information is not present in the characteristic information. It is also preferable that the distributing streams the contents in the chunks. It is desirable that the distributing transmits sequentially the contents in the chunks. It is also preferred that the distributing transmits buffer map information to the peer terminals and transmits the contents in the chunks at random based on the buffer map information.

The present invention provides a content redistribution system based on a peer-to-peer (P2P) network that can redistribute IPTV contents via a heterogeneous network. Being a viable distribution channel among the subscribers to an IPTV service using a P2P network, the content redistribution system of the present invention enables sharing and distribution of contents among the P2P users without having to require installation of high-cost facilities such as central-server clusters and regional servers. For example, some users could subscribe to an IPTV service and the others could be provided with content redistribution, sharing and distribution of user-generated contents in the form of P2P community service.

It is of particular importance to note that use of a distribution method of P2P type for contents allowed to redistribute allows the content provider to be relieved from the problems of load redistribution and accompanying cost present in the conventional centralized servers and hence the users can be provided with contents in a more efficient way. With the advent of user-generated contents and their need to establish and operate such a distribution infra-structure has been asserted widely because it provides an IPTV service at a reduced cost and load on the network. Since P2P service implements a virtualized network and it is the principal target of network infra-structures of the future, its employment for distribution of IPTV contents could induce significant promotion of IPTV.

### BRIEF DESCRIPTION OF THE DRAWINGS

The above features of the present invention will become apparent from the following description of embodiments, given in conduction with the accompanying drawings, in which:

FIG. 1 shows a block diagram of a content redistribution system based on a peer-to-peer network in accordance with an embodiment of the present invention.

FIG. 2 shows a detailed block diagram of a content management terminal of a content redistribution system based on a peer-to-peer network in accordance with an embodiment of the present invention.

FIG. 3 shows a flowchart of how contents are distributed by a content management terminal of a content redistribution system based on a peer-to-peer network in accordance with an embodiment of the present invention.

FIG. 4 shows a conceptual diagram of an example of how contents are distributed by a content management terminal of a content redistribution system based on a peer-to-peer network in accordance with an embodiment of the present invention.

### DETAILED DESCRIPTION OF THE EMBODIMENTS

Hereinafter, embodiments of the present invention will be described in detail with reference to the accompanying drawings.

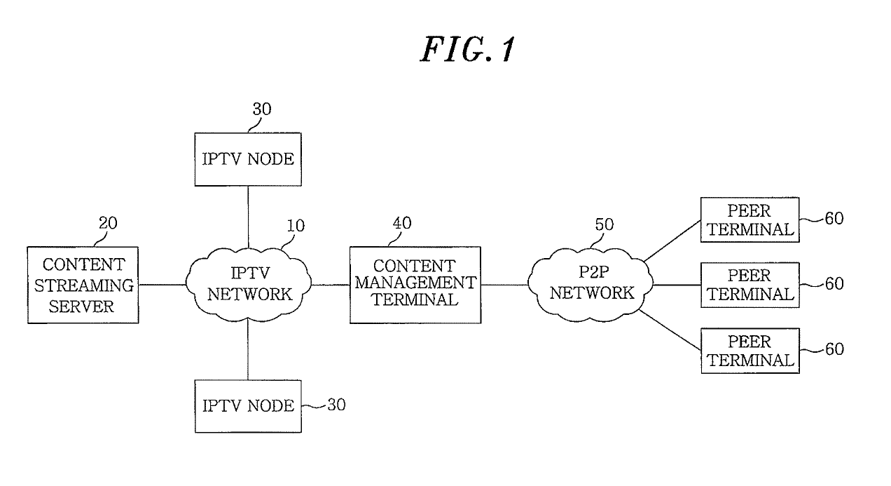

FIG. 1 shows a block diagram of a content redistribution system based on a peer-to-peer network in accordance with an embodiment of the present invention. The content redistribution of the present invention consists of an IPTV network 10, a content streaming server 20, IPTV nodes 30, a content management terminal 40, a P2P network and peer terminals 60.

Content streaming server 20 multicasts contents to IPTV nodes 30 subscribing to IPTV network 10 and to content management terminal 40. Note that IPTV network 10 can be formed in various headend systems that include content streaming server 20 together with an authentication server, an accounting server and an encoder that are not shown in the figure.

IPTV nodes 30 and content management terminal 40 receive IPTV contents via an IPTV content receiver such as its own private set-top box and displays such as television are used to play and watch the received contents.

While content management terminal 40 is on P2P network 50 and plays a role of a peer together with peer terminals 60, it is also on IPTV network 10, a heterogeneous network, at the same time. On IPTV network 10, it receives IPTV contents in streams from content streaming server 20 and then decides for redistribution based on content information.

Peer terminals 60 constitute P2P network 50 with content management terminal 40 and the content that are allowed to be distributed by content management terminal 40 is distributed to the terminals based on the data transmission rules in the community group on P2P network 50. For example, content management terminal 40 and the peer terminals can generate a P2P community group and distribute the contents to the members of the group.

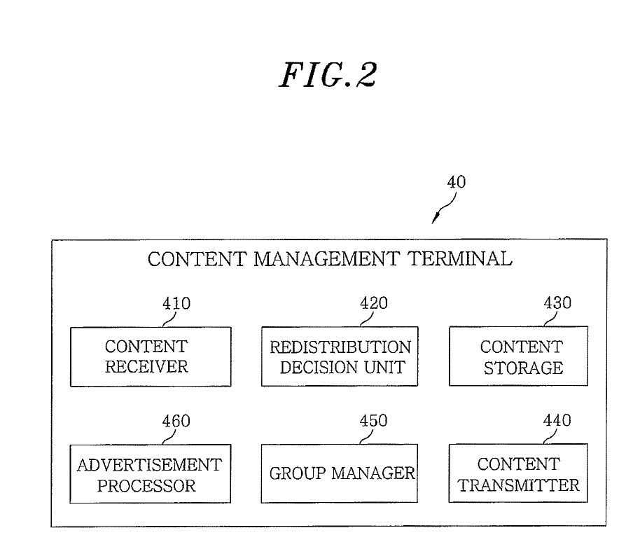

FIG. 2 shows a detailed block diagram of a content management terminal of a content redistribution system based on a peer-to-peer network in accordance with an embodiment of the present invention. Content management terminal 40 consists of a content receiver 410, a redistribution decision unit 420, a content storage 430, a content transmitter 440, a group manager 450 and an advertisement processor 460.

Content receiver 410 receives contents on an IPTV network, which is not a P2P network but a heterogeneous network, and passes to redistribution decision unit 420 and content storage 430.

Redistribution decision unit 420 decides for redistribution of the contents received by content receiver 410 based on the characteristic information of the contents.

Content storage 430 stores the contents received by content receiver 410 in chunks based on the chunk information in the characteristic information of the contents. If the chunk information is not present in the contents received by content receiver 410, however, the contents are stored in chunks of a prescribed size.

Group manager 450 stores and manages information about a community group on the P2P network generated or subscribed to by content management terminal 40. Once it generates a new community group and sends a message for requesting subscription to the new community group, authentications of the new community group and subscription to it can be processed afterwards.

Advertisement processor 460 transmits advertisements announcing the contents to peer terminals 60 subscribing to a community group according to the information about the community group.

Content transmitter 440 redistributes contents allowed to redistribute by the decision of redistribution decision unit 420 to the peer terminals requesting them in chunks via the community group on the P2P network based on the advertisements by advertisement processor 460.

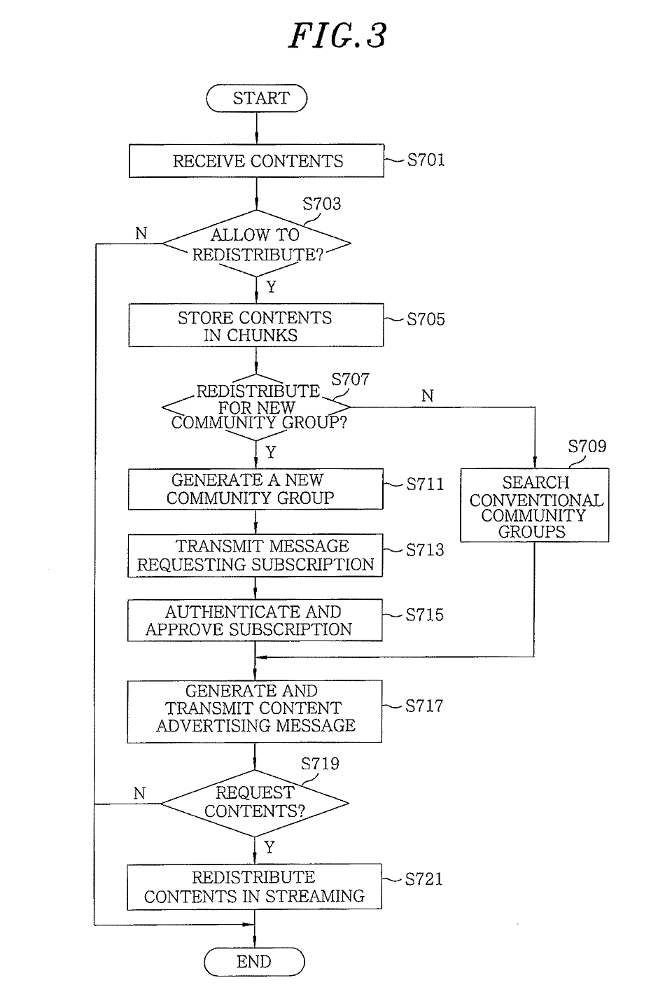

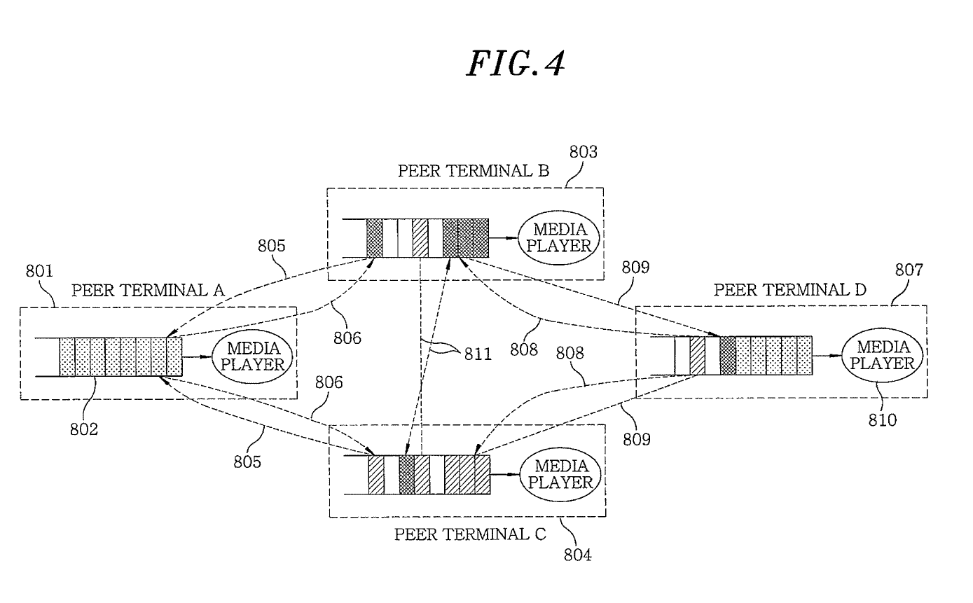

In what follows, a content redistribution system based on a peer-to-peer network and how contents are redistributed by a content management terminal are explained. An example is taken for a case of redistribution on a P2P network of IPTV contents on an IPTV network to facilitate understanding the explanation of the present invention as in FIGS. 3 and 4.

FIG. 3 shows a flowchart of how contents are distributed by a content management terminal of a content redistribution system based on a peer-to-peer network in accordance with an embodiment of the present invention.

At step S701, content receiver 410 of content management terminal 40 receives IPTV contents from content streaming server 20 on IPTV network 10 and passes to redistribution decision unit 420 and content storage 430.

At step S703, redistribution decision unit 420 decides for redistribution of contents received by content receiver 410 based on the characteristic information contained in the IPTV contents. For example, information about whether the IPTV content under consideration is protected by copyright is contained in the characteristic information of the content. Redistribution decision unit 420 decides against redistribution of the content if it is protected by copyright and for redistribution if not.

At step S705, content storage 430 stores the contents received by content receiver 410 in chunks based on the chunk information in the characteristic information contained in the IPTV contents. If the chunk information is not present in the IPTV contents received by content receiver 410, however, the contents are stored in chunks of a prescribed size.

At step S707, group manager 450 decides whether the IPTV contents are redistributed on the P2P network for a new community group or for an existing community group. The community group for which the redistribution is to be made is selected according to the prescribed state value or the option value that can be input by the user in real time.

If the contents are decided to be redistributed to an existing community group, at step S709, information about the community group under current management is searched and read in. If it is decided that the contents are redistributed to a new community group, a new community group is generated, at step S711, a subscription request message carrying a request for subscription to the generated community group is transmitted to peer terminals 60 on the P2P network, at step S713, and upon the request for subscription to the corresponding community group from peer terminals 60, the subscription is approved via an authentication procedure, at step S715.

At step S717, advertisement processor 460 generates an advertising message to announce IPTV contents and transmits the advertising message to peer terminals 60 subscribing either to an existing community group at step S709 or to a new community group at step S715, according to the information about the community group. That is, content management terminal 40 plays a role of an origin peer that floods the advertisement to peer terminals 60 in the community group. Of course, it is possible that the advertising message is not transmitted to the P2P network but any one of peer terminals 60 plays a role of the super peer that stores and manages information about respective contents in chunks and information about peers and provides with browsing them.

Content transmitter 440 redistributes, at step S721, in chunks through the community group on P2P network 50 the IPTV contents allowed to redistribute by the decision of redistribution decision unit 420 to the peer terminals requesting them, at step S719, based on the advertisements by advertisement processor 460.

The IPTV content redistributed at step S721 is transmitted in chunks since it is stored in chunks at step S705 based on the chunk information in the characteristic information contained in the IPTV content. However, when the chunk information of the IPTV content is not present, the IPTV content is transmitted in chunks, since in this case the content is stored at step S705 in chunks of a prescribed size.

The IPTV content can be transmitted by sequential streaming or, when content management terminal 60 plays a role of the super peer that sends the buffer map information to peer terminals 60, the IPTV content can be transmitted in chunks at random based on the buffer map information.

FIG. 4 shows a conceptual diagram of an example of how contents are distributed by a content management terminal of a content redistribution system based on a peer-to-peer network in accordance with an embodiment of the present invention.

Peer terminal A 801, for example, content management terminal 40 in FIG. 1, stores and manages in chunks the IPTV content received from the IPTV network, transmits advertising messages to peer terminals within a community group on the P2P network or stores information about the IPTV content on a separate content information management server, a role played by a specific peer terminal. Peer terminal B 803 and peer terminal C 804 recognize the existence of the IPTV content via the advertising message or the content information management server and carries out a chunk request 805, in response to which peer terminal A 801 provides peer terminals B and C with the corresponding IPTV contents, i.e. chunk delivery 806.

Upon receiving chunk request 808 of IPTV contents from peer terminal D 807, peer terminals B and C carry out chunk delivery 809 to peer terminal D. When the received source contents are assembled to reach a specific size, peer terminal D 807 transmits the IPTV contents to output devices such as a television via a media player 810. Reference 811 in FIG. 4 indicates that chunk delivery can take place between peer terminal B 803 and peer terminal C 804.

It is possible to write in a computer program the content distribution method of the content management terminal according to the present invention. The codes and code segments constituting this computer program can be easily deduced by a computer programmer in the pertinent area of expertise. The corresponding computer programs are stored in computer-readable storage media and are read and executed by a computer so that the content distribution method of the content management terminal is realized on the computer. Here, the computer-readable storage media include magnetic storage media, optical storage media and carrier-wave media.

While the invention has been shown and described with respect to the embodiments, it will be understood by those skilled in the art that various changes and modifications may be made without departing from the scope of the invention as defined in the following claims.

What is claimed is:

1. A content redistribution system based on a peer-to-peer (P2P) network, comprising:
a content management terminal that, being a peer of said P2P network, decides for redistribution of contents based on characteristic information included in said contents received via a heterogeneous network; and
peer terminals to which are distributed said contents decided for redistribution according to data transmission regulations in a community group on said P2P network.

2. The content redistribution system of claim 1, wherein said content management terminal receives said contents from a streaming server on an internet protocol television network as said heterogeneous network.

3. The content redistribution system of claim 1, wherein said content management terminal stores and transmits said contents in chunks based on chunk information included in said characteristic information.

4. The content redistribution system of claim 1, wherein said content management terminal stores and transmits said contents in chunks of a prescribed size if chunk information is not present in said characteristic information.

5. The content redistribution system of claim 3, wherein said content management terminal transmits sequentially said contents in said chunks.

6. The content redistribution system of claim 3, wherein said content management terminal transmits buffer map information to said peer terminals and transmits said contents in said chunks at random based on said buffer map information.

7. A content management terminal that is a member of a peer-to-peer (P2P) network and manages contents, comprising:
a content receiver that receives said contents via a heterogeneous network;
a redistribution decision unit that decides for redistribution based on characteristic information included in said contents;
a content storage that stores in chunks contents received by said content receiver;
a group manager that stores and manages information about a community group;
an advertisement processor that transmits messages advertising said contents based on information about said community group to peer terminals affiliated with said community group; and
a content transmitter that redistributes in said chunks said contents decided for redistribution to said peer terminals which request said contents based on said advertising messages.

8. The content management terminal of claim 7, wherein said heterogeneous network is a streaming server on an internet protocol television network.

9. The content management terminal of claim 7, wherein said content receiver and said content transmitter store and transmit said contents in said chunks based on chunk information included in said characteristic information.

10. The content management terminal of claim 7, wherein said content storage stores and transmits said contents in chunks of a prescribed size if chunk information is not present in said characteristic information.

11. The content management terminal of claim 9, wherein said content transmitter transmits sequentially said contents in said chunks.

12. The content management terminal of claim 9, wherein said content transmitter transmits buffer map information to said peer terminals and transmits said contents in said chunks at random based on said buffer map information.

13. A content distribution method for a content management terminal that is a member of a peer-to-peer (P2P) network and manages contents, comprising:
receiving said contents via a heterogeneous network;
deciding for redistribution based on characteristic information included in said contents; and
distributing said contents decided for redistribution to said peer terminals on said P2P network according to data transmission regulations in a community group on said P2P network.

14. The content distribution method of claim 13, wherein said receiving receives said contents from a streaming server on an internet protocol television network as said heterogeneous network.

15. The content distribution method of claim 13, wherein said distributing transmits said contents in chunks based on chunk information included in said characteristic information.

16. The content distribution method of claim 13, wherein said distributing transmits said contents in chunks of a prescribed size if chunk information is not present in said characteristic information.

17. The content distribution method of claim 15, wherein said distributing transmits sequentially said contents in said chunks.

18. The content distribution method of claim 15, wherein said distributing transmits buffer map information to said peer terminals and transmits said contents in said chunks at random based on said buffer map information.
